(19) United States
(12) Patent Application Publication
(10) Pub. No.: US 2011/0171117 A1
(43) Pub. Date: Jul. 14, 2011

(54) METHOD AND SYSTEM FOR INCREASING HYDROGEN YIELD/PRODUCTION IN A REFINERY

(75) Inventors: Alan Gorski, Long Beach, CA (US); Oluwasijibomi Okeowo, Clayton, CA (US); Ming Wang, El Sobrante, CA (US)

(73) Assignee: Chevron U.S.A. Inc.

(21) Appl. No.: 12/980,487

(22) Filed: Dec. 29, 2010

Related U.S. Application Data
(60) Provisional application No. 61/291,303, filed on Dec. 30, 2009.

(51) Int. Cl. C01B 3/50; B01J 8/00; C01B 3/56

(52) U.S. Cl. 423/650; 423/648.1; 422/187

(57) ABSTRACT

A method and system for capturing hydrogen gas in a refinery is disclosed. The system comprises a first membrane and pre-reformer. The membrane is suitable for separating a refinery fuel gas feed, which includes hydrogen gas and hydrocarbon gases, into a hydrogen gas depleted retentate stream and a hydrogen gas enriched permeate stream. The pre-reformer receives the retentate stream from the first membrane and catalytically converts the retentate stream into an outlet stream of hydrogen and methane gases. The system may further include a reformer which receives at least a portion of the outlet stream and catalytically converts the methane gas into hydrogen and carbon oxides. A second membrane may be used for separating the outlet stream into a second hydrogen depleted retentate stream and second hydrogen enriched permeate stream. The reformer, in this case, receives the second hydrogen depleted retentate stream to provide methane for steam reforming. Because hydrogen is removed from the original refinery fuel gas feed fed to the pre-reformer and/or the outlet stream fed to the reformer, additional hydrocarbons can be fed to the pre-reformer and/or reformer, in place of the removed hydrogen gas, to increase the overall hydrogen gas production from the system.

### RELATED REFERENCES

This application claims priority to U.S. Ser. No. 61/291,303, filed on Dec. 30, 2009, and is entitled “Method and System for Increasing Hydrogen Yield/Production in A Refinery Reformer”.

### TECHNICAL FIELD

The present invention relates generally to extract hydrogen gas for use in refineries, and more particularly, to separate hydrogen gas from refinery fuel off-gases and gases from pre-reformers and reformers.

### BACKGROUND OF THE INVENTION

Increasing refinery crude feed rates, refining lower quality crudes, expansion of existing refinery process units, and meeting more stringent product specifications contribute to an increase in hydrogen demand in refineries. Hydroprocessing and product post-treating units are primary consumers of hydrogen in refineries. To meet this increased demand for hydrogen, existing hydrogen production units could be expanded or new hydrogen production units could be built. Alternatively, better use of existing supplies of hydrogen within a refinery could also be utilized.

A pre-reformer is a reactor in which hydrocarbon-containing gases, such as ethane, propane and butane, are catalytically converted or cracked into hydrogen and methane gases. The pre-reformer could be a steam naptha reformer (SNR) where naptha is also converted to methane gases. Naptha refers to flammable liquid hydrocarbon mixtures such as are obtained as volatile fractions in the fractional distillation of petroleum, often C₄₊ hydrocarbon gases. A steam methane reformer (SMR) catalytically converts methane, in the presence of steam, into hydrogen gas and carbon oxides (CO_{X}), such as carbon monoxide and carbon dioxide.

FIG. 1 illustrates an exemplary conventional refinery system 10 wherein hydrogen gas is produced. Streams 12, 14 and 16 of refinery fuel gases are collected from various refinery processes. Examples of such processes are fluid catalytic cracking (FCC), hydrocracking, and hydrotreating. The phrase, “refinery fuel gas” refers to off gases produced in reactions in a refinery and which contain hydrogen and hydrocarbon containing gases. Typically, these off gases of interest contain from 10-60 by mole % of hydrogen, although the hydrogen content may be higher or lower than this range in some cases.

Valves 20, 22 and 24 are used to control the flow of streams 12, 14 and 16. A valve 26 controls the flow of a combined stream 28 of refinery gases that is supplied to a pre-reformer 36. Also introduced into pre-reformer 36 is a stream 40 of naptha which is controlled by valve 42. The pre-reforming or cracking of the hydrocarbons in pre-reformer 36 can be an endothermic or exothermic reaction, but it is typically considered adiabatic and the pre-reforming produces heat when higher molecular weight hydrocarbons are cracked into methane. Reaction temperatures typically range from 300° C. to 500° C. Ideally, the feed stream 28 to pre-reformer 36 is supplied at close to the reaction temperature in the pre-reformer 36.

To minimize the addition of heat needed to drive endothermic reactions, ideally the gases introduced into pre-reformer 36 are at a relatively high temperature such as 100° C. or 150° C. or greater. Equation (1) below generally shows the reaction occurring within pre-reformer 36 as C₂₊ hydrocarbons are cracked into methane and hydrogen. Note that excess hydrogen gas will be present in the event that not all hydrogen is converted to methane.

CₙH₂ₙ₊₂+(n−1)H₂→nCH₄(+H₂ excess hydrogen) (1)

A stream 44 of methane and hydrogen gases generated by pre-reformer 30 is delivered to a valve 50 that, in turn, passes the stream of methane and hydrogen to a steam methane reformer 60. A stream 62 of steam is also provided to reformer 60. The steam reforming is also an endothermic reaction so the temperature of the methane and hydrogen gas feed 44 to reformer 60 should be kept at an elevated temperature as well. Reformer 60 catalytically converts the feed 44 of methane and hydrogen gas and steam into an outlet stream 64 of hydrogen gas and carbon monoxide and/or carbon dioxide. The hydrogen gas and carbon monoxide and/or carbon dioxide are cooled and then separated such as by using an amine treatment (not shown) to remove carbon dioxide.

At high temperatures (700-1100° C.) and in the presence of a metal-based catalyst, steam reacts with methane to yield hydrogen, carbon monoxide and carbon dioxide gases. The steam methane reformer is typically operated at a temperature of 500-1000° C. and pressure of 8-35 atmospheres.

Two typical reactions which occur in the steam methane reformer are reversible in nature and are listed below:

CH₄+H₂O→CO+3H₂ (2)

CO+H₂O→CO₂+H₂ (3)

Removing hydrogen from a stream of hydrocarbon gases at high temperatures and pressures is challenging. Depending on the hydrogen and heavy hydrocarbon concentrations contained in an off-gas stream produced during a refinery operation, the hydrogen can be recovered with a conventional polymeric membrane and pressure swing adsorption (PSA) process technologies. S. Peramanu et al., Economics of Hydrogen Recovery Processes for the Purification of Hydroprocessor Purge and Off-gases, International Journal of Hydrogen Energy 24 (1999) 405-424. However, due to the presence of heavy hydrocarbons in the process streams, the application of polymeric membranes is limited because of the potential damaging effect of the hydrocarbons on the polymeric materials due to plasticization. PSA application is also limited in recovery of hydrogen in refinery off-gases because the hydrogen concentrations are typically lower than the range considered economical for PSA. In addition, cryogenic technology can be used to recover hydrogen but the cost and complexity of the process makes it uneconomical in most instances for removing hydrogen from refinery off-gas streams.

Various authors have described different forms of membranes and processes for hydrogen recovery. Richard Baker et al., U.S. Pat. No. 6,159,272, Hydrogen Recovery Process, suggests a hydrogen recovery process using rubbery polymeric membranes, particularly those membranes that are reverse selective, i.e., membranes having selectivity for the larger components (or more condensable components). This process also involves a prior cooling step in which a portion of heavier hydrocarbons is removed from a stream before passing the uncondensed portion of the stream to a membrane. These rubbery polymeric membranes are particularly useful for streams with high hydrogen concentrations, i.e., 90 mole % and above. In addition, Richard Baker et al., U.S. Pat. No. 6,011,192, Membrane-based Conditioning for Adsorption System Feed Gases, describes the use of membranes having C₁₊ selectivity to increase hydrogen concentration of a gas stream feed into an adsorption process.

Richard Barchas et al., U.S. Pat. No. 5,082,481, Membrane Separation Process for Cracked Gases, describes hydrogen recovery with membranes for streams containing at least one olefin, followed by cooling/refrigeration of the stream coming out of the membrane to effect more separation. Different types of application membrane materials (polymeric, ceramic, glass membranes) are described.

Rao et al., U.S. Pat. No. 5,447,549, Hydrogen Recovery by Adsorbent Membranes, describes the use of an integrated adsorbent-type membrane and PSA to recover hydrogen with the hydrogen recovered on the high pressure side while the heavier hydrocarbon components are recovered on the permeate side. Because the membranes used in this application rely on the adsorption of heavier hydrocarbons to effect separation, the process is limited to low temperature applications.

Gauthier et al., U.S. Pat. No. 7,211,706, Process for recovering hydrogen in a gaseous hydrocarbon effluent using a membrane reactor, describes the application of different types of hydrogen-selective membrane materials (glassy polymers, metals, zeolites, carbon membranes, ceramic) in a membrane reactor for the continuous removal of hydrogen in processes like fluidized-bed catalytic cracking, steam reforming, catalytic reforming, gasification etc. The membrane is located internal to a reactor rather than being located externally upstream or downstream of a reactor. The membranes provide the advantage of driving reactions to completion by continuously removing hydrogen as conversion reactions are taking place.

There is a need for a process and system for hydrogen recovery at high temperatures and pressures to increase hydrogen availability for refinery operations by increasing the capacity of pre-reformers and reformers to convert hydrocarbon containing feed gases into hydrogen.

### SUMMARY OF THE INVENTION

A method and system for capturing hydrogen gas in a refinery is disclosed. The system comprises a first membrane and pre-reformer. The membrane is suitable for separating a refinery fuel gas feed, which includes hydrogen gas and hydrocarbon gases, into a hydrogen gas depleted retentate stream and a hydrogen gas enriched permeate stream. The pre-reformer receives the retentate stream from the first membrane and catalytically converts the retentate stream into an outlet stream of hydrogen and methane gases. The system may further include a reformer which receives at least a portion of the outlet stream and catalytically converts the methane gas into hydrogen and carbon oxides. A second membrane may be used for separating the outlet stream into a second hydrogen depleted retentate stream and a second hydrogen enriched permeate stream. The reformer, in this case, receives the second hydrogen depleted retentate stream to provide methane for steam reforming. Because hydrogen is removed from the original refinery fuel gas feed fed to the pre-reformer and/or the outlet stream fed to the reformer, additional hydrocarbons can be fed to the pre-reformer and/or reformer, in place of the removed hydrogen gas, to increase the overall hydrogen gas production from the system.

The method comprises providing a refinery fuel gas feed comprising hydrogen and hydrocarbon containing gases to a first separation membrane. The refinery fuel gas feed is separated using the membrane to produce a first hydrogen gas depleted retentate stream and a first hydrogen gas enriched permeate stream. The retentate stream is supplied to a pre-reformer wherein hydrocarbon containing gases are converted into an outlet stream of hydrogen and methane gases. Optionally, the outlet stream of hydrogen and methane gases is separated by a second membrane into a second hydrogen depleted gas retentate stream and a second hydrogen gas enriched permeate stream. The methane gas in the second retentate stream may then be converted in a reformer into hydrogen and carbon oxides. Further, the method may include adding a hydrocarbon containing gas to at least one of the outlet stream and the second retentate stream to increase the amount of hydrocarbons introduced into the reformer. With more hydrocarbons being introduced in the reformer, a greater quantity of hydrogen and carbon oxides may be produced than if the feed to the reformer had not had the hydrogen gas removed.

### BRIEF DESCRIPTION OF THE DRAWINGS

These and other objects, features and advantages of the present invention will become better understood with regard to the following description, pending claims and accompanying drawings where:

FIG. 1 illustrates a conventional pre-reforming and reforming process configuration;

FIG. 2 shows a novel pre-reforming and reforming process configuration with membranes used for hydrogen gas separation and recovery prior to the pre-reforming of a refinery fuel gas and/or prior to reforming of methane in a steam methane reformer; and

FIG. 3 depicts a flow chart for material balance for a hydrogen recovery process which was computer modeled to show the benefits of the present invention over conventional pre-forming and reforming refinery operations.

### DETAILED DESCRIPTION OF THE INVENTION

A process and system are disclosed for the recovery of high temperature hydrogen from refinery off-gas streams that feed a pre-reformer that cracks C₂₊ hydrocarbon gases and/or naptha into hydrogen and methane gas. Similarly, high temperature hydrogen may be captured downstream from the pre-reformer and upstream of a steam methane reformer (SMR) resulting in the overall increase in the production of hydrogen gas by the pre-reformer and reformer. In one embodiment, a carbon molecular sieve membrane is used to effect the separation of hydrogen from other hydrocarbon containing gases. Alternatively, by way of example and not limitation, other membranes such as ceramic or metal membranes, may also be used which are suitable for high temperature gas separations.

It has been discovered that the presence of hydrogen in an off-gas or refinery fuel feed to a pre-reformer can limit the throughput and conversion of hydrocarbons through the pre-reformer because of the capacity taken up by the excess of inert hydrogen passing through the pre-reformer. That is, the presence of any hydrogen in excess of the stoichiometric requirements for the pre-reforming or cracking reaction in the pre-reformer will not contribute to the additional formation of hydrogen from the cracking of C₂₊ feed stream or naptha. Similarly, the level of feed conversion in a steam methane reformer (SMR) may be limited by hydrogen in the feed to the reformer due to Le Chatelier's principle, (in the reforming reaction) because of the presence of the inert hydrogen in the reaction.

Removal of some of the inert hydrogen from the feed (over the stoichiometric amount required for a reaction—e.g. in a pre-reforming reaction)—prior to the pre-reformer will allow increasing the supply of light hydrocarbons in the pre-reformer feed and subsequent conversion to methane. The total increase in hydrogen production is the sum of the hydrogen separated and recovered from the refinery off-gases supplied to the pre-reformer and the additional hydrogen produced during conversion in the pre-reformer because more hydrocarbons can now be converted in the pre-reformer in the absence of excess inert hydrogen.

The application is particularly advantageous in situations where the hydrogen plant (pre-reformer and reformer) is limited in capacity due to the amount of “inert” hydrogen contained in its feed. As an example, assume that a membrane, such as a high throughput and high temperature carbon molecular sieve (CMS) membrane, removes 4 MMSCFD (Million Standard Cubic Feet per Day) of “inert” hydrogen from the reformer feed. Removal of this inert hydrogen then allows an additional 4 MMSCFD of methane (natural gas or off-gas) to be fed to the reformer to make an additional 16 MMSCFD of H₂ (assuming complete conversion of methane to hydrogen).

The stream conditions for the refinery fuel gas off gases or feeds are generally in the temperature range of 350° F.-700° F. and around 300 to 500 psig for pressure. Such conditions are harsh for conventional membranes because of the high temperature condition, and thus a significant amount of cooling is required to bring the refinery feed gas to the low temperature range suitable for the conventional membranes. In addition, to achieve a meaningful level of separation efficiency with the membrane selectivity, the permeate/downstream pressure of the membrane (conventional) process must be maintained at a much lower pressure to maintain a high pressure feed/permeate ratio driving force.

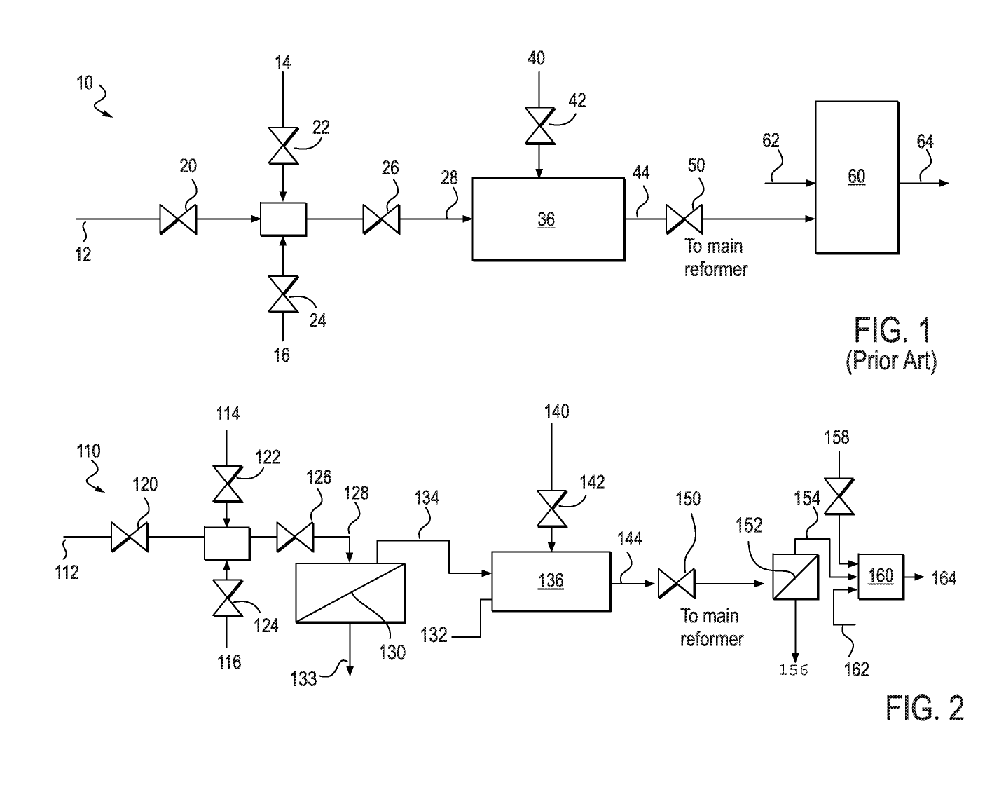

FIG. 2 shows a novel pre-reforming and reforming process configuration utilizing one or more membranes for hydrogen separation and recovery. This process configuration may be useful in the retrofit of existing hydrogen plants, such as the one displayed in FIG. 1. In this exemplary embodiment, a system 110 includes three streams 112, 114 and 116 of refinery fuel gases containing light hydrocarbon and hydrogen gases. Examples of such processes, by way of example and not limitation, are fluid catalytic cracking (FCC), hydrocracking, and hydrotreating. Valves 120, 122 and 124 at least partially control the flow of streams 112, 114 and 116, in conjunction with a valve 126, to produce a combined overall stream 128 of hydrogen and light hydrocarbon gases. Of course, one or many more streams of refinery fuel gas feeds may be combined to form stream 128 rather than the three suggested in this exemplary embodiment. A membrane 130 is utilized to separate stream 128 into a hydrogen enriched permeate stream 133 and a hydrogen depleted retentate stream 134. Ideally, stream 134 would contain 94 mole % or more of hydrogen gas. A stream of steam 132 is fed to a pre-reformer 136, as is a stream 140 of naptha. A valve 142 is used to control the input flow rate of the stream 140 of naptha.

Pre-reformer 136 catalytically cracks the hydrocarbon containing stream 134 and naptha stream 140 into a stream 144 of hydrogen and methane gases. A valve 150 is used to control the flow of stream 144. Stream 144, containing hydrogen and methane gases, is fed to a membrane 152 wherein a hydrogen depleted retentate stream 154 and a hydrogen enriched permeate stream 156 are created. The hydrogen depleted retentate stream 154, along with a stream 162 of steam and optionally an additional hydrocarbon containing stream 158, is fed to a reformer 160 wherein the hydrocarbons, such as methane and ethane, may be converted to a stream 164 of hydrogen and carbon oxides (CO and CO₂). As the hydrogen has been removed from feed streams 134 and 144, more hydrocarbons are available for conversion in pre-reformer 136 and reformer 160 due to removal of stoichiometric excess of hydrogen from the pre-reformer 136 and/or 160.

Those skilled in the art will appreciate that system 110 might be used with only membrane 130 removing hydrogen gas from stream 128 and not utilizing membrane 152 to remove hydrogen gas downstream from pre-reformer 136, if so desired. Likewise, system 110 might be modified to use only membrane 152 to remove hydrogen from stream 144 and not use membrane 130 to separate hydrogen gases from stream 128. The stream 128 would, instead, be fed directly to pre-reformer 136.

In system 110, the removal of hydrogen from streams 128 and 148 results in increased hydrogen availability for refinery operations as a result of 1) increases in hydrogen captured from hydrogen enriched permeate streams 132 and 156; and 2) reduction in gas flow volume flowing into pre-reformer 136 and reformer 160 by removing “inert” hydrogen gas thus freeing up capacity for makeup methane or other light hydrocarbon gases to be added for more H₂ production.

Ideally a robust membrane possessing high thermal and chemical resistance is utilized in the present invention. Membranes may be used of known designs such as hollow fiber membranes, flat sheet membranes, and tubes and which are mounted in suitable housings or modules.

One preferred example of such a membrane is a carbon molecular sieve membrane. For example, a polymer could be pyrolized on to a porous support capable of withstanding high temperatures. Hydrogen gas permeates through the membrane to the permeate/downstream side and the rejected components (now depleted in hydrogen) remains on the high pressure retentate/reject side. A preferred CMS membrane would ideally have a high H₂/CH₄ selectivity (>50) and high permeance (>500 GPU Gas Permeation Unit, 1×10⁻⁶ cm³STP/cm²·sec·cmHg) which makes it more amenable to high temperature and pressure refinery applications. The combination of permeance and selectivity allows hydrogen recovery to be tuned as desired by changing membrane area and/or feed/permeate pressure ratio.

Carbon molecular sieves membranes (CMS) are typically prepared by carbonizing thermosetting polymer precursors at high temperatures ranging from 400-1000° C. See May-Britt Hagg et al., The Recovery by Carbon Molecular Sieve Membranes of Hydrogen Transmitted in Natural Gas Networks, International Journal of Hydrogen Energy 33 (2008) 2379-2388.

The pore sizes and shapes of the resulting membranes typically depend on the starting materials and the pyrolysis conditions. CMS membranes have been reported to exhibit very high selectivity and permeability for hydrogen. As a result of the high temperature treatment involved in the membrane preparation, CMS membranes have very high thermal stability properties that makes them suitable for high temperature operations. For example, see A. Mendes et al., Carbon Molecular Sieve Membranes: Sorption, Kinetic, and Structural Characterization, Journal of Membrane Science 241 (2004) 275-287, Wei Wei et al., Preparation of supported Carbon Molecular Sieve Membrane from Novolac Phenol-Formaldehyde Resin, Journal of Membrane Science 303 (2007) 80-85 and Theodore T. Tsotsis et al., Transport and Morphological Characteristics of Polyetherimide-Based Carbon Molecular Sieves, Industrial Engineering Chemistry Research 38 (1999) 3367-3380.

Saufi and Ismail., Fabrication of Carbon Membranes for Gas Separation—A review, Carbon 42 (2004) 241-259, provides an overview for carbon membrane fabrication. Carbon membranes are fabricated by pyrolysis of a suitable polymeric precursor under controlled conditions. Various aspects of fabrication were reviewed including: precursor selection, polymeric membrane preparation, pretreatment of the precursor, pyrolysis process, post-treatment of pyrolyzed membranes and module construction.

Examples of CMS membranes which may be used in the present invention are described in US patents as well. One example is Wu et al., U.S. Pat. No. 5,262,198, Method of Producing a Carbon Coated Ceramic Membrane and Associated Product. A method is described for producing a carbon coated ceramic membrane that includes passing a selected hydrocarbon vapor through the ceramic membrane and controlling ceramic membrane exposure temperature and ceramic membrane exposure time. The method produces a carbon coated ceramic membrane of reduced pore size and modified surface properties having increased chemical, thermal and hydrothermal stability over an uncoated ceramic membrane. The disclosure of this patent is hereby incorporated by reference in its entirety.

As another alternative, a ceramic membrane as described in Liu et al, U.S. Pat. No. 5,611,931, High Temperature Fluid Separations using Ceramic Membrane Device, could also be used with the present invention. A high temperature ceramic membrane device for separation of fluids at high temperature is disclosed. The device comprises housing which cooperates with a ceramic membrane comprised of porous ceramic tubes permeable by a fraction of the fluid to be removed from the fluid as filtrate and impermeable to a second fraction. The disclosure of U.S. Pat. No. 6,611,931 is hereby incorporated by reference in its entirety.

Metal membranes having sufficient thermal stability, permeance and selectivity may also be used. For example, U.S. Pat. No. 6,649,559 discloses a Supported Metal Membrane and Process for its Preparation and Use. The disclosure of U.S. Pat. No. 6,649,559 is hereby incorporated by reference in its entirety.

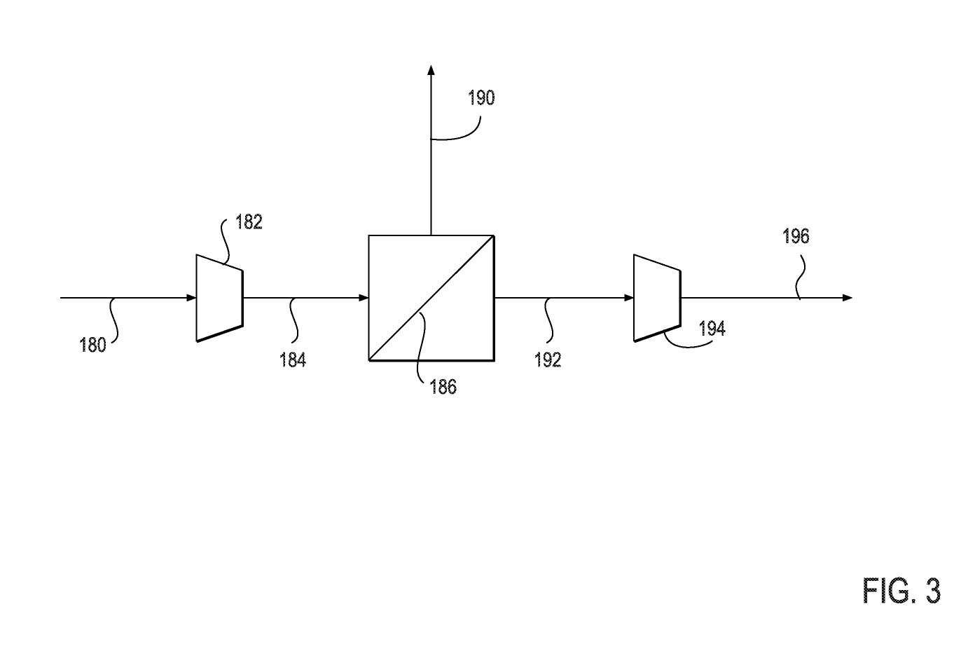

FIG. 3 shows a schematic of a material balance flow that was modeled using ASPEN HYSYS, a commercial simulation software product available from Aspen Technology Inc., Cambridge, Mass. A feed stream 180 of hydrogen and hydrocarbon components is fed to a feed compressor 182. Feed stream 180 was assumed to have 61.8 mole % hydrogen gas (H₂) and 10.5 mole % methane (CH₄). Additional components of feed stream 180 are shown in Table 1 below. The feed stream is delivered at a pressure of 90 psig at a flow rate of 15 MMMSCFD to compressor 182. A higher-pressure stream 184, i.e., 230 psig, is produced by feed compressor 182 using an estimated 914 horsepower by compressor 182.

Stream 184 is fed to a membrane 186. It is assumed that membrane 186 has a membrane selectivity of 50 and permeance value of 500 GPU. A hydrogen depleted retentate stream 190 and hydrogen enriched permeate stream 192 are produced using membrane 186. The retentate stream 190 has a composition of 10% H₂ and 23.6% CH₄ at a pressure of 230 psig and flow rate of 6.2 MMMSCFD. The permeate stream 192 exits at 20 psig. The permeate stream 192 is passed to a permeate compressor 194 to produce a high pressure hydrogen enriched permeate stream 196 at 525 psi. Compressor 194 is estimated to require 2971 horsepower. Permeate stream 196 has an estimated 98.1 mole % H₂ and 1.3 mole % CH₄ at a flow rate of 8.8 MMMSCFD. Accordingly, use of a high temperature membrane with good permeance and selectivity allows for significant hydrogen recovery in stream 196 and volume reduction of hydrogen in the retentate stream 190.

TABLE 1
Process Stream Material Balance for Process Schematic

| | Feed | Reject | |
|---|---|---|---|
| | Mole % | Mole % | Permeate Mole % |
| C6+ | 0.2 | 0.4 | 0.0 |
| Hydrogen | 61.8 | 10.0 | 98.1 |
| Propane | 9.7 | 23.3 | 0.2 |
| Propene | 0.0 | 0.0 | 0.0 |
| i-Butane | 3.4 | 8.3 | 0.0 |
| n-Butane | 2.7 | 6.6 | 0.0 |
| i-Pentane | 0.7 | 1.8 | 0.0 |
| n-Pentane | 0.2 | 0.5 | 0.0 |
| Ethane | 10.7 | 25.5 | 0.3 |
| Methane | 10.5 | 23.6 | 1.3 |

Table 2 below shows the effect of varying the feed conditions. A simple two-component hydrogen/methane feed stream model was used. In a first scenario, the feed comprises a relative high percentage of hydrogen gas at 76 mole % hydrogen and a flow rate of 32 MMSCFD and at a pressure of 100 psig. This feed is fed through a membrane having a hydrogen/methane selectivity of 50 and a permeance of 500 GPU. The resulting separated product has a product specification of ≧94% hydrogen at a total through put of 20 MMSCFD. In scenario 2, the feed has a 55% mole of H₂ at 20 MMMCFD at 130 psig. The product recovered after separation was at ≧94 mole % of H₂ at a rate of 10 MMMSCFD. Finally, utilizing a relatively low hydrogen feed of 35% H₂, 12 MMMSCFD, 130 psig, the product recovered is ≧94% H₂ at 3 MMMSCFD.

TABLE 2
Off-gas Stream Composition for Hydrogen Recovery and Potential Purity
and Recovery

| | | Product |
|---|---|---|
| | Feed Conditions | Specification |
| Scenario 1 | 76% H2, 32MMSCFD, 100 psig | ≧94% H₂, 20MMSCFD |
| Scenario 2 | 55% H2, 20MMSCFD, 130 psig | ≧94% H₂, 10MMSCFD |
| Scenario 3 | 35% H2, 12MMSCFD, 130 psig | ≧94% H₂, 3MMSCFD |

Table 3 shows the relative purity of the hydrogen gases recovered in each of the scenarios of Table 2. Also, the percentage of hydrogen recovered in permeate stream from each of the scenarios is shown.

TABLE 3
Percentage Recovery of Hydrogen in Feed Stream

| | Scenario 1 | Scenario 2 | Scenario 3 |
|---|---|---|---|
| H2 Purity (mol %) | 98 | 96 | 94 |
| H2 Recovery (%) | 94 | 86 | 53 |

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A method for recovering hydrogen gas in a refinery, the method comprising:
(a) providing a refinery fuel gas feed comprising hydrogen and hydrocarbon containing gases;
(b) separating the refinery fuel gas feed using a membrane to produce a first hydrogen gas depleted retentate stream and a first hydrogen gas enriched permeate stream;
(c) supplying the retentate stream to a pre-reformer and converting hydrocarbon containing gases into an outlet stream of hydrogen and methane gases.

2. The method of claim 1 further comprising:
(d) separating the outlet stream of hydrogen and methane gases into a second hydrogen depleted gas retentate stream and a second hydrogen gas enriched permeate stream; and
(e) converting in a reformer the methane gases of the second retentate stream into hydrogen and carbon oxides.

3. The method of claim 2 wherein:
the first and second hydrogen gas enhanced permeate streams are combined to form a combined hydrogen gas stream.

4. The method of claim 3 further comprising:
adding a hydrocarbon containing gas to at least one of the outlet stream and the second retentate stream to increase the amount of hydrocarbons introduced into the reformer.

5. The method of claim 1 wherein:
naptha is supplied to the pre-reformer to enhance the amount of hydrocarbons converted in the pre-reformer.

6. The method of claim 1 wherein:
the membrane is selected from one of the group consisting of a carbon molecular sieve membrane, a ceramic membrane and metal membrane.

7. The method of claim 1 wherein:
the membrane is a carbon molecular sieve membrane.

8. The method of claim 1 wherein:
the first refinery fuel gas feed which is separated is in excess of 100° C.

9. The method of claim 1 wherein:
the first refinery fuel gas feed which is separated is in excess of 200° C.

10. The method of claim 1 wherein:
the first hydrogen gas enhanced permeate stream has at least 94 mole % of hydrogen gas.

11. The method of claim 1 further comprising:
supplying naptha to the pre-reformer to replace the hydrogen removed from the refinery fuel gas stream thereby increasing the amount of hydrocarbon gases which are converted in the pre-reformer to the outlet stream of hydrogen and methane gas thereby enhancing the amount of methane produced in the outlet stream.

12. A system for capturing hydrogen gas in a refinery, the system comprising:
(a) a first membrane suitable for separating a first refinery fuel gas feed into a hydrogen gas depleted retentate stream and a hydrogen gas enriched permeate stream; and
(b) a pre-reformer in fluid communication with the first membrane to receive the retentate stream from the first membrane and catalytically converting the retentate stream into an outlet stream of hydrogen and methane gases.

13. The system of claim 12 further comprising:
a reformer which receives at least a portion of the outlet stream and catalytically converts the methane gas into hydrogen and carbon oxide.

14. The system of claim 13 further comprising:
a second membrane for separating the outlet stream into a second hydrogen depleted retentate stream and a second hydrogen enriched permeate stream;
wherein the reformer receives the second hydrogen depleted retentate stream.

15. The system of claim 13 further including:
a source of hydrocarbon gas which supplements the hydrogen depleted retentate stream supplied to the reformer.

16. The system of claim 12 wherein:
the first membrane is a carbon molecular sieve membrane made by pyrolyzing a polymer.

17. The system of claim 16 wherein:
the polymer is pyrolized onto a ceramic support.

18. A method for recovering hydrogen gas in a refinery, the method comprising:
(a) providing a feed stream comprising hydrogen and methane gases;
(b) separating the feed stream using a membrane to produce a first hydrogen gas depleted retentate stream containing methane and a first hydrogen gas enriched permeate stream; and
(c) supplying the retentate stream to a reformer and converting the methane to hydrogen and carbon oxides gases.
